(19) United States
(12) Patent Application Publication
(10) Pub. No.: US 2013/0194665 A1
(43) Pub. Date: Aug. 1, 2013

(54) THREE PORTS TURNABLE FILTER ARRAY

(71) Applicants: Lifu GONG, San Jose, CA (US); Hongwei MAO, Fremont, CA (US); Gongjian HU, Marina, CA (US)

(72) Inventors: Lifu GONG, San Jose, CA (US); Hongwei MAO, Fremont, CA (US); Gongjian HU, Marina, CA (US)

(21) Appl. No.: 13/359,224

(22) Filed: Jan. 26, 2012

(51) Int. Cl. G02B 5/30

(52) U.S. Cl. 359/491.01

(57) ABSTRACT

A tunable filter array comprises a serial of tunable filters each has an input optical port and at least two output optical ports. All of the tunable filters commonly share a polarization conditioning optics, a polarization selective beam routing optics, a wavelength selective beam spatial separation/combination optics and a polarization controlling element array. The serial tunable filters are packaged by vertically stacking multiple sets of the input and output optical ports. The wavelength dependent beam separation/combination optics disperses an input optical beam into a two dimensional array of beam spots to focus on the two dimensional polarization control element array for controlling the polarization states of each of the beam spots. The polarization selective beam routing optics selectively routes the reflected beam from the wavelength dependent beam separation/combination optics to the output optical ports according to the polarization states of a wavelength segment corresponding to the beam spots.

### BACKGROUND OF THE INVENTION

This invention relates to tunable filter arrays used in optical communication systems and more specifically to a compact three ports tunable filter array.

As the wavelength division multiplexing (WDM) systems are commonly employed for transmitting optical signals in multiple signal channels, one common challenge is to provide compact and adjustable tunable filters configured as array to dynamically and flexibly control the dropped or continuous transmissions of different channels. In order to control the signal transmission of multiple channels, especially when array of tunable filters are manufactured and assembled, it is often necessary to tradeoff between the size of the array package or to sacrifice the controllability and flexibilities of the channel adjustments and/or the variation ranges of the signal intensities among signals of different wavelengths.

A WDM system that employs multiple optical signal channels for signal transmissions is broadly applied in the optical communication systems. Because of the transmission capacities and the advancement of technologies, WDM systems have become a substantial and fast-growing constituent of communication networks. Such communication systems include telecommunications systems, cable televisions systems, and local area networks (LANs) and many other types of network systems for signal transmission.

Since the WDM systems employ multiple optical signal channels to transmit signals and each channel is assigned to transmit signal of particular wavelength, the transmission capacity is greatly increased. To start the signal transmissions, optical signals are generated at the different channel wavelengths and then multiplexed to form a multiplexed optical signal for transmitting over a single fiber or waveguide. Then, the multiplexed signals are de-multiplexed such that each channel wavelength is individually routed to a designated receiver.

In many such applications, the WDM signal transmission systems have a need to route one or more of the multiplexed channels to different destinations. The signal routing processes may require the signals of specific optical channels be sent to or withdrawn from an optical transmission link. Wavelength selective processes for transmitting or withdrawal specific signals are necessary in order to transmit signals in certain optical channels between a specific signal transmission terminal to an optical bus for routing telecommunication signals to reach individual cities. The operations are similar to that of the control of a long distance traffic. The process of selectively withdraw and continuous transmission of signals at a transmission station is generally referred to as a continue-drop process. An optical filter including a tunable filter is commonly used to carry out the wavelength selection in order to perform the “continue-add” process.

Various tunable filters have been disclosed including tunable filters that are assembled as filter array. However, such tunable filters, such as the tunable filters disclosed in U.S. Pat. Nos. 6,449,410, 7,777,957, and 7,898,740. However, the tunable filters or filter array disclosed in these patented disclosures have configurations that are not suitable for further size reduction in order to make compact filter array to satisfy modern applications, Furthermore, the tunable filters as disclosed in these patented disclosures do not provide sufficient flexibility of wavelength selections and therefore, the signal routing capabilities are limited.

For these reasons, there are still needs exist in the art of optical signal transmission and communication to provide improved tunable filter array with compact size and increased flexibilities of wavelength selections such that the above discussed difficulties and limitations may be resolved.

### SUMMARY OF THE PREFERRED EMBODIMENTS

Therefore, an aspect of this invention is to provide a serial of three-ports one-by-two (1×2) drop-continue tunable filters configured as vertically stackable array wherein all of these tunable filters share common optical components to form a compact and integrated array package such that the difficulties and limitations as that encountered in conventional tunable filters can be resolved.

Specifically, it is an aspect of this invention to provide a serial tunable filters configured as vertically stacked sets of an input port and two output ports with these sets of input and output ports wherein all of these set of 3-ports share a polarization selective routing optics, a wavelength dependent beam separation optics and polarization controlling element array to function as array of tunable filters to dynamically control the wavelength selective process to carry out the continue-add signal routing operations as that required by the telecommunication and signal transmission networks.

Another aspect of this invention is to provide a serial tunable filters configured as vertically stacked sets of an input port and two output ports with these sets of input and output ports wherein all of these 3-ports share a set of common optical components including a two dimensional polarization controlling element array including liquid crystal on silicon (LCOS) pixels to control the polarization state of beam spots corresponding to different wavelength channels. The ratio of continue-drop output beams is controllable and dynamically tunable in real time by controlling the polarization state of each of these beams spots thus tuning and adjusting the signals dropped and continue to transmit in the WDM optical transmission system can be carried out with increased flexibilities.

Another aspect of this invention is to provide a serial tunable filters configured as vertically stacked sets of an input port and two output ports with these sets of input and output ports wherein all of these 3-ports share a set of common optical components including a wavelength dependent beam separation optics to disperse the input beams from every tunable filter of the stack horizontally along dispersion direction based on their wavelength. The light beams from different wavelength channel of different tunable filter of the stack are mapped onto a two dimensional polarization controlling element array such that the wavelength selection process for dropping and continuing transmission of optical signals for different input spectrum segments with any predetermined ratio can be flexibly and accurately adjusted and controlled.

In a preferred embodiment, this invention discloses a tunable filter array. The tunable filter array comprises a serial of tunable filters each has an input optical port and at least two output optical ports wherein all of the tunable filters commonly share a polarization conditioning optics, a polarization selective beam routing optics, a wavelength selective beam spatial separation/combination optics and a polarization controlling element array. The serial tunable filters are packaged by vertically stacking multiple sets of the input and output optical ports. The wavelength dependent beam separation/combination optics disperses the input optical beams from the filter stack into a two dimensional array of beam spots to focus on the two dimensional polarization control element array for controlling the polarization states of each of the beam spots. The polarization selective beam routing optics selectively routes the reflected beam from the wavelength dependent beam separation/combination optics to the output optical ports according to the polarization states of a wavelength segment corresponding to the beam spots.

In a preferred embodiment, this invention discloses a method for packaging a tunable filter array having a serial of tunable filters each has an input optical port and at least two output optical ports. The method comprises a step of vertically stacking multiple sets of the input and output optical ports and packaging and commonly sharing a polarization conditioning optics, a polarization selective beam routing optics, a wavelength selective beam spatial separation/combination optics and a polarization controlling element array with the vertically stacking multiple sets of the input and output optical ports in a tunable filter array package.

These and other features and advantages of the invention will be apparent to those skilled in the art from the following detailed description of preferred embodiments, taken together with the accompanying drawings, in which the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a functional block diagram to illustrate the optical path of a 3-ports/1×2 drop-continue tunable filter array on wavelength dispersion plans of this invention.

FIG. 2 is a side cross sectional view of the tunable filter array for illustrating the layout and the optical paths of the filter array of this invention.

FIG. 3 is a two dimensional diagram for illustrating the beam spot locations of different wavelength channels of the filter array distributed on the LOCOS panel

FIG. 4 is a diagram to show the normalized intensity distributions among the ports as a function of the polarization angles

FIG. 5 is a diagram for illustrating typical pass band and stop band shapes of the tunable filter of this invention.

FIG. 6 is a functional block diagram to illustrate a second embodiment of a optical path of a 3-ports/1×2 drop-continue tunable filter array on wavelength dispersion plans of this invention

FIG. 7 is a side cross sectional view of the tunable filter array of FIG. 6 for illustrating the layout and the optical paths of the filter array of this invention.

### DETAILED DESCRIPTION OF THE PREFERRED EMBODIMENTS

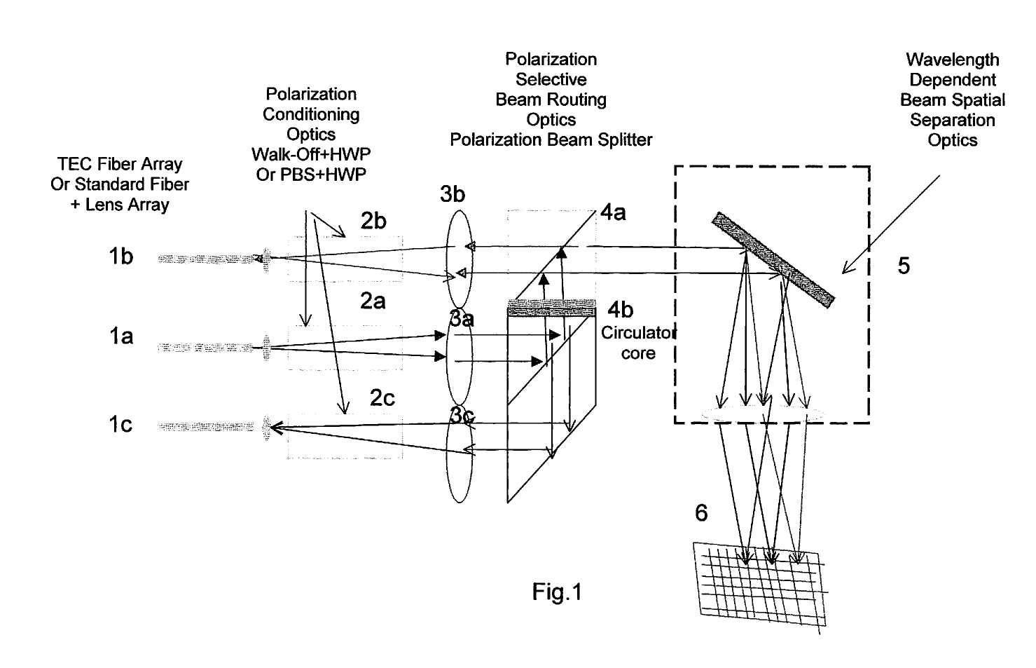

FIG. 1 is a functional diagram for showing a multiple ports tunable filter array configuration and the optical paths to illustrate the color dispersion plane for each channel of different wavelengths. In this diagram the layout of the filter array arrangement is shown along a vertical plane that is perpendicular to the color dispersion plane.

As shown in FIG. 1, the input signals are projected into the multiple ports tunable filter through the input feeding optics 1a. The feeding optics la may include a fiber array and micro lens array or mode expanded fiber array. The feed optics reduces the divergence angle of the input beams to a certain value so that when the input beams are transmitted to the polarization conditioning optics 2a, the polarization conditioning optics 2a can more easily handle the beams. The polarization conditioning optics may be implemented with walk-off crystal and half-wave plate (HWP) or a combination of polarization beam splitter (PBS) and half-wave plate (HWP). The input beams are randomly polarized are then converted by the polarization beam conditioning optics 2a into two beams with identical polarizations.

After transmitted through the polarization conditioning optics, the beams are further collimated by the collimating lenses 3a and then passing through a polarization selective beam routing optics 4 to project onto a grating functioning as a wavelength dependent beam spatial separation optics 5. The grating that functions as wavelength dependent beam spatial separation optics 5 diffracts the input beams comprising different wavelength segments with different diffraction angles to project onto a Fourier imaging lens to focus different spectrum segments of the input beams onto pre-designated spots on a focus plane on a two-dimensional liquid crystal (LC) surface that comprises a polarization controlling element array 6. The polarization controlling element array may be implemented as a liquid crystal on silicon (LCOC) device. Each of these polarization controlling elements is independently controllable to rotate the polarization of the reflected light beam projected onto the elements.

All the beams projected onto the polarization controlling element array 6 are reflected back to pass through the Fourier imaging lens back to the grating 5 with the polarization of each of the beams distributed over different wavelength channels controlled by one of the corresponding polarization controlling elements on the LCOS device. The angular color dispersion of the grating is cancelled out when the beams are reflected back and the reflected beams with spectrum dispersion distributed over different wavelength channels are recombined according to the new polarization states that are controlled by the LCOS device 6. Then the recombined beams are directed to different outputs 3B and 3C according to their polarization states via the polarization selective beam routing optics 4. The beams with the polarization rotated ninety degrees on the LOCOS 6 are reflected back and output into the fiber array 1b. The beams with the polarization unchanged are reflected back through the Magnetic-optic Garnet and the half-wave-plate with the polarization rotated by 90 degrees and routed to the output port 1c.

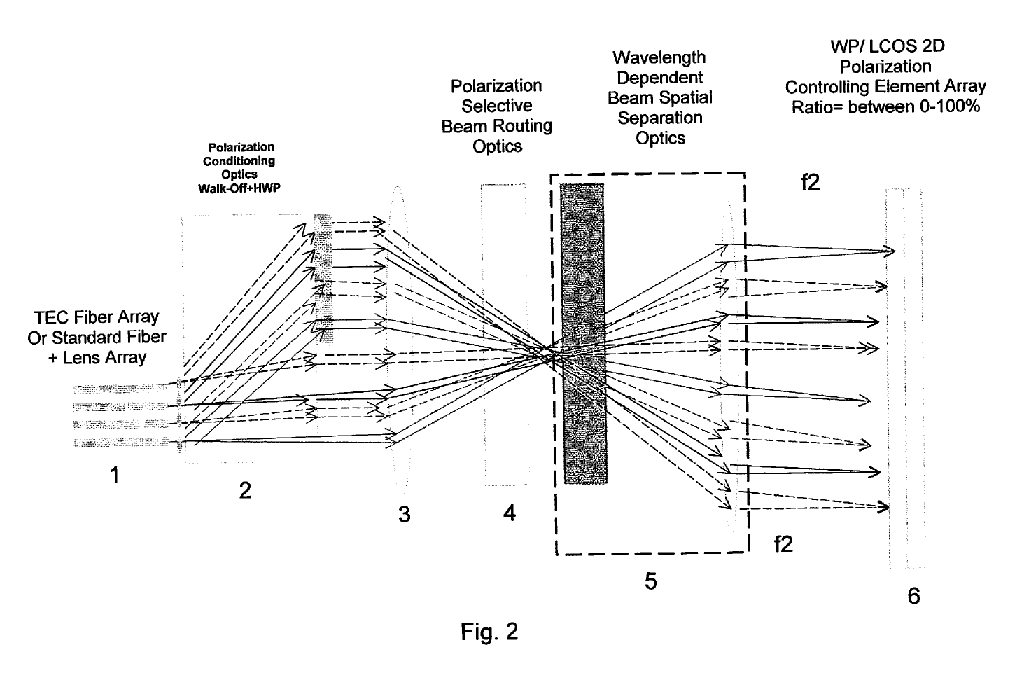

FIG. 2 shows a vertical cross sectional view of the layout of the filter array for illustrating the optical paths for four of 1×2 drop-continue tunable filters wherein each filter is configured according to FIG. 1. These four 1×2 drop-continue tunable filters arranged along a vertical plan as a filter array has a compact configuration by sharing as many optical parts as possible and arranging the beam paths as compact as possible.

The random polarized input beam of each filter in the array is inputted through fiber la as that shown in FIG. 1. The divergence angle of the input beam is reduced by the micro-lens or mode expanded filter tip (TEC fiber). Then the beam is transmitted into the polarization conditioning optics 2 that is implemented with a walk-off birefringence crystal and a half-wave plate. The beam is converted into two beams with the same polarization. The ordinary beam maintains the same beam transmission direction and the extraordinary beam is transmitted toward an upward direction to a top portion of the walk-off crystal 2 and passes through the half-wave plate. The polarization of the extraordinary beam is rotated 90 degrees by the half wave plate such that the exited beam after the half-wave plate is of the same polarization as the ordinary beam. The micro-lens or the TEC fibers are designed to keep the divergence angle of the extraordinary beam smaller than the walk-off angle. The beams transmitted out from the polarization conditioning optics 2 are further collimated the collimate lens 3 to pass through the polarization selective beam routing optics 4 and the wavelength dependent beam spatial separation optics, e.g., the grating device 5, and then focused by the Fourier lens in 5 onto the LCOS panel 6 that comprises a polarization control element array to control the polarization of different beams separately projected to different spots on the panel.

The light beams from the input fibers of the input array are one-to-one mapped onto the LCOS device 6 by a 4f configuration. Since there are two groups of beams after the beams pass through the polarization conditioning optics 2, there are two groups of beam spots projected onto the LCOS device 6 after the 4f mapping. The 4f optical configuration is realized by placing the grating at back focus plane of the collimating lens 3 and the front focus plane of the Fourier lens 5.

As shown in FIG. 2, the grating and Fourier imaging lens are shared by all filters of the array and used to separate the input beams with different wavelengths into different spots at the focal plane of the of the Fourier image lens. Therefore, the LCOS polarization control element array 6 can independently control the polarization states for each of these beam spots corresponding to different spectrum segments.

Specifically, at the focus plane of the two dimensional LCOS polarization controlling array 6, each control element of the controlling array is independently controlled to generate independent polarization state for each of the beam spots projected onto the two dimensional array. After the changes of the polarization states are completed, the reflected beams are again projected through the polarization beam separation optics that is shared among all the filters, to distribute the beam into two output ports. The transmission ratios of the output beams in each of these output ports are adjustable by controlling the polarization states of the reflected beams from the LCOS polarization controlling element array.

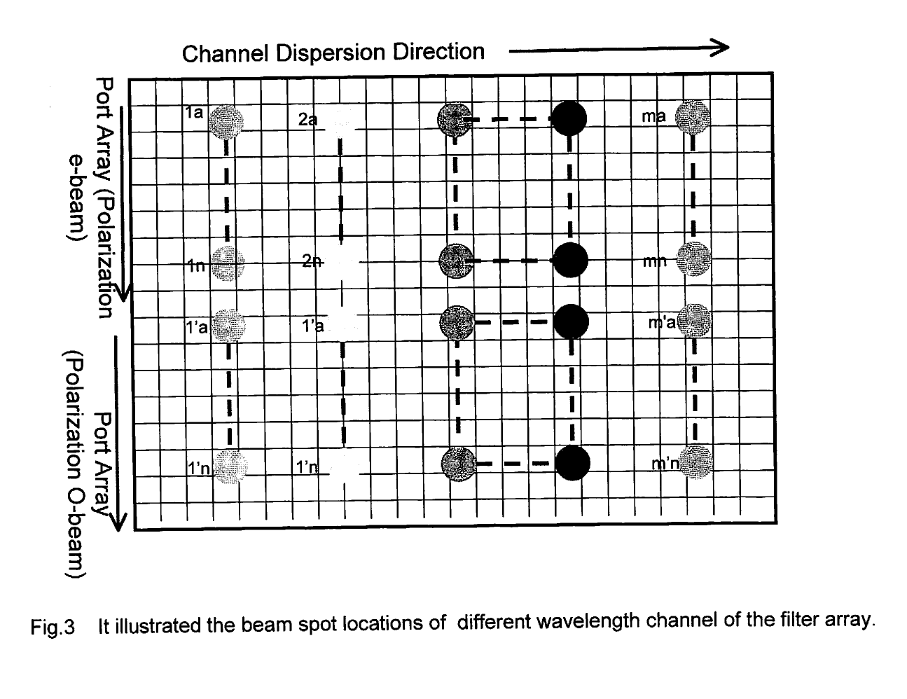

Since the LOCS polarization control element array is implemented as a liquid crystal (LC) device, the beams projected onto the surface of the LOCS polarization control element array must first be converted into predetermined polarized beams by the polarization condition optics 2 and then distributed onto the two dimensional LOCS polarization control element array 6 by the wavelength dependent beam spatial separation optics as that shown in FIGS. 1 and 2. FIG. 3 is a diagram to illustrating the beam spots distribution on the LOCS polarization control element array 6.

Therefore, according to FIGS. 2 and 3, each of these 3-ports 1×2 drop-continue tunable filters is implemented to distribute the input beam into two output ports. Different spectrum segments of the input beams can be distributed into two output ports according to a predetermined and tunable ratio. Specifically, in FIG. 3, the beam splitting ratios are functionally dependent on the polarization for each of the 3-ports 1×2 drop-continue tunable filters for transmitting different wavelength segments. The two-dimensional LCOS polarization control element array is implemented for an tunable filter array that includes 1, 2, 3, . . . , n integrated vertically stacked 3-ports 1×2 drop-continue tunable filters for transmitting and tuning optical signals transmitted over 1, 2, 3, . . . m wavelength segments, i.e., wavelength channels. Therefore, the beams received from input ports 1a, 2a, 3a, . . . na, with wavelength ranges between the m-channels are projected as beam spots according to the wavelength segments across the horizontal direction and distributed over vertical direction according to the input ports 1a, 2a, . . . , na and 1a′, 2a′,3a′, . . . , na′ for the ordinary and extraordinary polarization beams, i.e., the polarization e-beam and the polarization o-beam for beams received from 1a, 2, 3a, . . . , na.

Each of the beams for different tunable filters transmitted over different wavelength segments is projected as a beam spot onto a control element that can be independently controlled to generate independent polarization state. Total flexibility is achievable to adjust drop-continue ratios of different wavelength channels for the array of the 3 ports/1×2 drop-continue tunable filter array. By controlling the LOCS control elements for adjusting the polarization states, the reflected beams are again projected through the polarization beam separation optics that is shared among all the filters, to distribute the beam into two output ports. The transmission ratios of the output beams in each of these output ports are adjustable by controlling the polarization states of the reflected beams from the LCOS polarization controlling element array

Therefore, the tunable filter array as that shown in FIGS. 1 to 3, comprises multiple input and output fiber arrays arranged in vertical layers to constitute a serial of 3-ports 1×2 drop-continue tunable filters. Each of these 3-ports 1×2 drop-continue tunable filters are operated independently, but in the meantime, all of these 3-ports 1×2 drop-continue tunable filters are packed in a single compact package. The compact configuration by packaging multiple independently operable filters into one package is made possible because the special optical configuration as shown in FIGS. 1 and 2. Specifically, other than the input-output fiber ports that are arranged on different vertical levels, all of these 3-ports 1×2 drop-continue tunable filters share a common set of optical components.

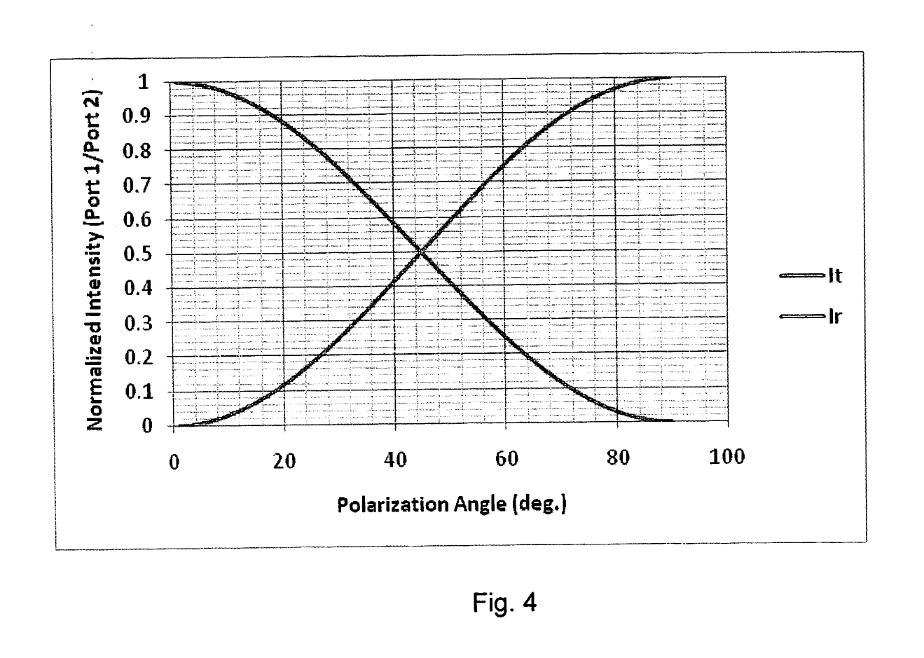

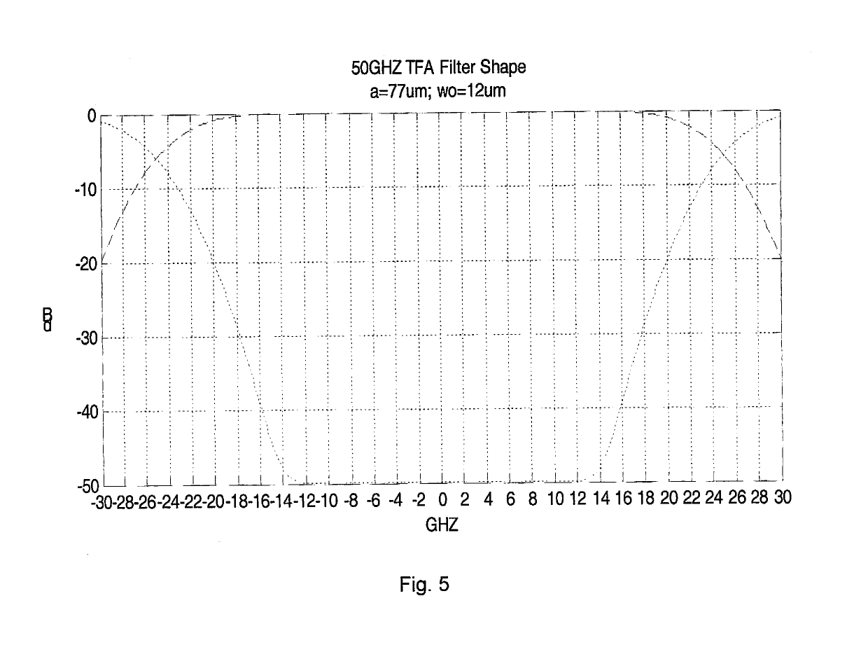

For the operation of each of the 3-ports 1×2 drop-continue tunable filters, the LCOS polarization control element may be flexible controlled to adjust the polarization angles for each of these beam spots to control the amount of beam intensities outputted through the drop-continue ports 1b, 2b, . . . nb and 1c, 2c, . . . , nc respectively. FIG. 4 shows the normalized output beam intensity distribution among the drop-continue ports as a function of the polarization angle as that adjusted and controlled by the LCOS polarization control element array for each of the spots shown in FIG. 3. A typical pass band and stop ban filter shape of the tunable filter of this invention is shown in FIG. 5. The vertical axis of the diagram is the optical transmission loss in a unit of db and the horizontal axis of the diagram is the wavelength in the unit of GHz. A very good flat tops filter shape is achievable by properly selecting the focusing beam spot size and channel separation on the LCOS.

The tunable filter array of this invention has a key feature of sharing optical parts with the optical paths arranged to transmit in very compact configuration. The size of the array package is limited by the filter specifications that limit the cross interferences between the filters. The beam separation on 2D polarization controlling element array for different filter should be large than 2-3 times of spot size to keep the cross talk between different filter below a small tolerance level for maintaining a high quality signal transmission.

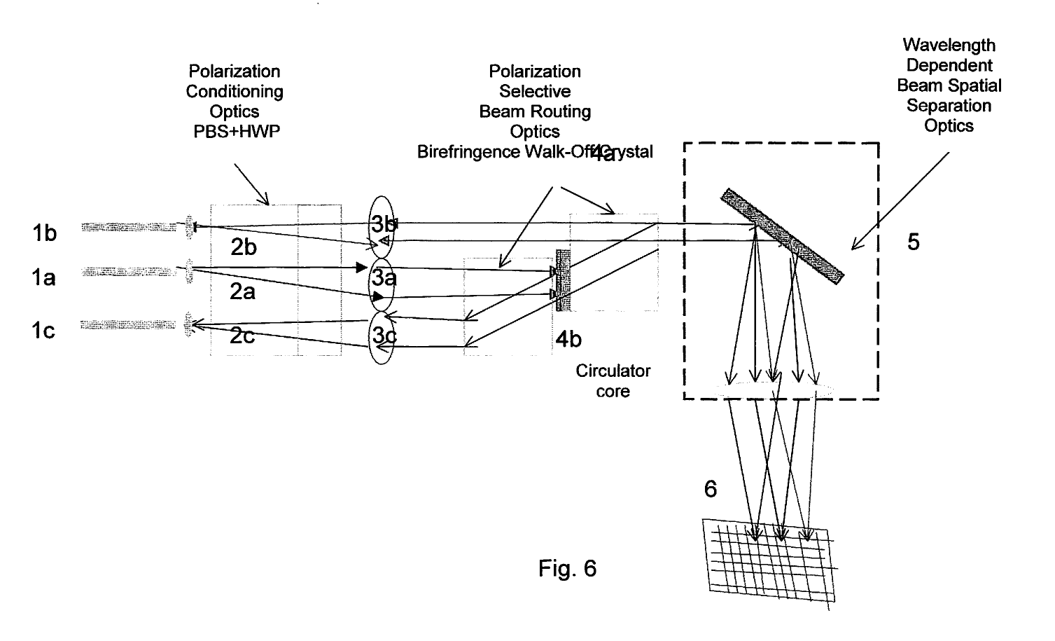

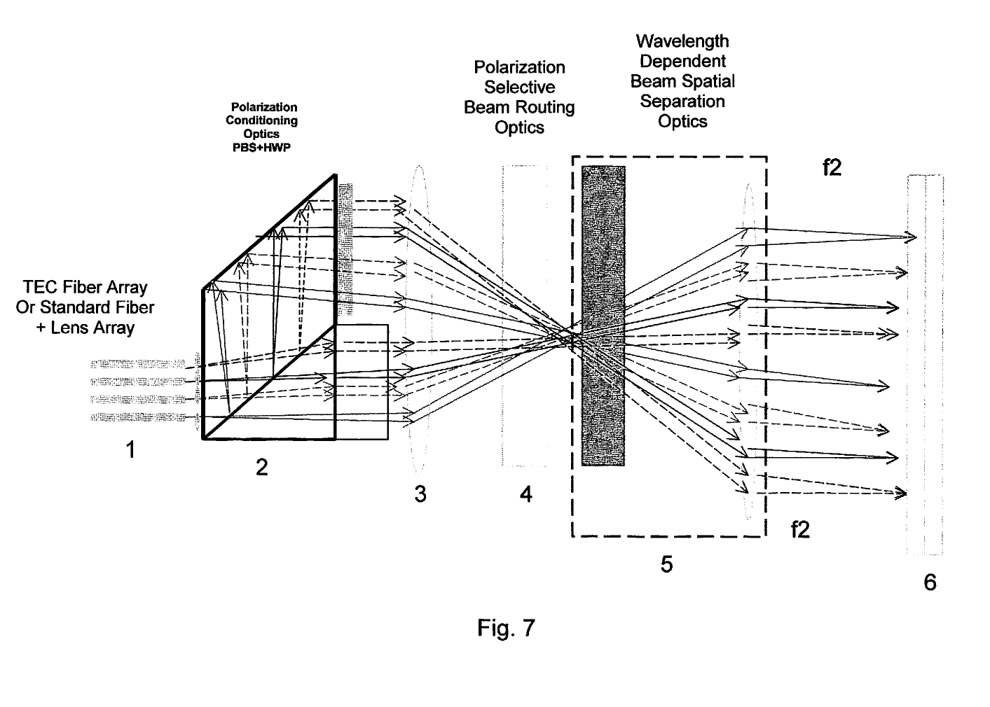

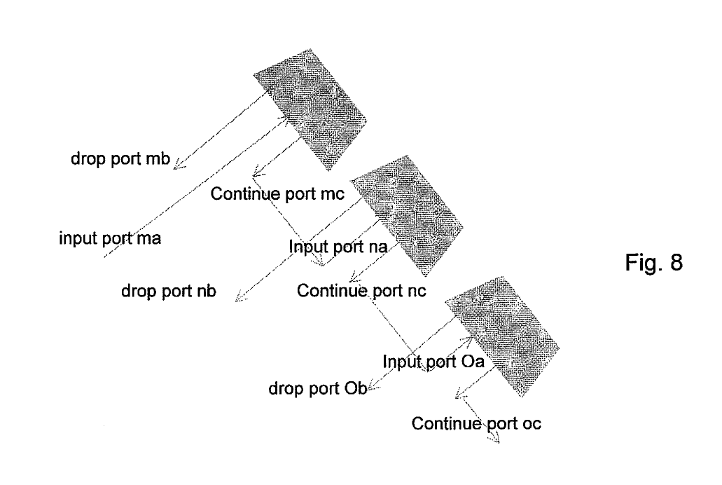

FIGS. 6 and 7 show another embodiment of this invention wherein the subassemblies 2′ and 4′ are different from the subassemblies 2 and 4 of FIGS. 1 and 2. The polarization conditioning optics 2′a, 2′b and 2′c comprise a polarization beam splitter (PBS) and a half-wave plate (HWP). The polarization beam splitter is made in this embodiment to provide same optical thickness for the two polarization splitting arms. The subassembly 4′a and 4′b, i.e., the polarization selective beam routing optics, comprise two pieces of walk-off birefringence crystals and a combination of a Garnet and half wave plate.

FIG. 8 shows a special feature of this array of three-port drop-continue tunable filter array. The special feature is the application of this tunable filter array to carry out the broadcasting distribution of multiple signals to multiple drop ports by looping the continue port of one filter and the input port of next filter within the filter array. FIG. 8 shows the continue port (i−1)C of the filter (i−1) among array of N filters (i=1, 2, 3, . . . , N), is looped to the input port Ai of another continue port i, and the ith continue port iC is looped to next input port (i+1)A. The end user in different drop ports (i−1)B, iB and (i+1)B can dynamically subscribe to different services provided in each of these wavelength channels flexibly.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. A tunable filter array package comprising:
a serial of tunable filters each having an input optical port and at least two output optical ports wherein:
all of the tunable filters commonly share a polarization conditioning optics, a polarization selective beam routing optics, a wavelength selective beam spatial separation/combination optics and a two-dimensional polarization controlling element array; and
the serial tunable filters are packaged by vertically stacking multiple sets of the input and output optical ports.

2. The tunable filter array package of claim 1 wherein:
the polarization selective beam routing optics selectively routes the reflected beam from the wavelength dependent beam separation/combination optics to the output optical ports with a predetermined tunable ratio according to the polarization states of a wavelength segment controlled by the two dimensional polarization controlling element array.

3. The tunable filter array package of claim 1 wherein:
the polarization controlling element array comprises a plurality of polarization control elements distributed as a two-dimensional array each of the control elements is controllable to adjust the polarization state of an optical beam projected onto each of the polarization control elements.

4. The tunable filter array package of claim 1 wherein:
the polarization controlling element array comprises a plurality of liquid crystal on silicon (LCOS) polarization control elements distributed as a two-dimensional LOCS array each of the LOCS control elements is controllable to adjust the polarization state of an optical beam projected onto each of the polarization control elements.

5. The tunable filter array package of claim 1 wherein:
the wavelength dependent beam separation/combination optics disperses an input optical beam into a two dimensional array of beam spots to focus and distribute the beam spots according to wavelength segments along a first direction and a sequential order of the serial of tunable filters along a second direction on the polarization controlling element array for controlling the polarization states of each of the beam spots.

6. The tunable filter array package of claim 1 wherein:
the polarization selective beam routing optics comprises polarization beam splitters and a combination of a garnet and a half-wave plate.

7. The tunable filter array package of claim 1 wherein:
the polarization conditioning optics further includes a walk-off crystal and a half-wave plate (HWP).

8. The tunable filter array package of claim 1 wherein:
the polarization conditioning optics further includes a polarization beam splitter (PBS) and a half-wave plate (HWP).

9. The tunable filter array package of claim 1 wherein:
the output port of at least one filter is looped to input port of at least another tunable filter in the tunable filer array package.

10. The tunable filter array package of claim 1 wherein:
the polarization selective beam routing optics further comprises two pieces of walk-off birefringence crystals and a combination of a garnet and a half-wave plate.

11. The tunable filter array package of claim 1 wherein:
the wavelength dependent beam spatial separation optics further comprises gratings to diffract input beams comprising different wavelength segments into different diffraction angles.

12. The tunable filter array package of claim 11 wherein:
the wavelength dependent beam spatial separation optics further comprises a Fourier imaging lens to focus beams diffracted by the grating for different spectrum segments onto pre-designated spots on a focus plane of the polarization controlling element array comprising a two-dimensional liquid crystal (LC) surface.

13. The tunable filter array package of claim 12 wherein:
The two-dimensional LC surface further comprising a plurality of liquid crystal on silicon (LOCS) elements for reflecting and rotating a polarization of beams projected onto each of the LOCS elements

14. The tunable filter array package of claim 13 wherein:
the beams reflected back from the LOCS elements are configured to pass through the Fourier imaging lens back to the grating and then through the polarization selecting beam routing optics, the collimating lens, the polarization conditioning optics and projection to the output ports depending on the polarization states wherein the reflected beams are transmitted in a reverse direction and sharing the commonly share polarization conditioning optics, polarization selective beam routing optics, wavelength selective beam spatial separation/combination optics and polarization controlling element array.

15. The tunable filter array package of claim 1 wherein:
the tunable filter array package comprising a plurality of vertically stacked 3-ports/1×2 drop-continue tunable filters with the two output ports comprise a drop port and a continue port.

16. The tunable filter array package of claim 1 wherein:
at least one of the continue or drop ports is looped to at least another input or output port in the tunable filter array package.

17. A method for packaging a tunable filter array having a serial of tunable filters each has an input optical port and at least two output optical ports, comprising
vertically stacking multiple sets of the input and output optical ports; and.
packaging and commonly sharing a polarization conditioning optics, a polarization selective beam routing optics, a wavelength selective beam spatial separation/combination optics and a polarization controlling element array with the vertically stacking multiple sets of the input and output optical ports in a tunable filter array package.

18. The method of claim 17 wherein:
the process of packing and commonly sharing the polarization controlling element array further comprises step of packaging and sharing the polarization controlling element array comprising a plurality of polarization control elements distributed as a two-dimensional array with each of the control elements controllable to adjust the polarization state of an optical beam projected onto each of the polarization control elements.

19. The method of claim 17 wherein:
the process of packing and commonly sharing the polarization controlling element array further comprises step of packaging and sharing the polarization controlling element array comprising plurality of liquid crystal on silicon (LCOS) polarization control elements distributed as a two-dimensional LOCS array with each of the LOCS control elements controllable to adjust the polarization state of an optical beam projected onto each of the polarization control elements.

20. The method of claim 17 wherein.
the process of packing and commonly sharing the wavelength dependent beam separation/combination optics and the polarization controlling element array further comprises step of packaging and sharing the wavelength dependent beam separation/combination optics to disperse an input optical beam into a two dimensional array of beam spots to focus and distribute the beam spots according to wavelength segments along a first direction and a sequential order of the serial of tunable filters along a second direction on the polarization controlling element array for controlling the polarization states of each of the beam spots.
